(19) United States
(12) Patent Application Publication
(10) Pub. No.: US 2020/0229344 A1
(43) Pub. Date: Jul. 23, 2020

(54) VISUAL OBSTACLE AVOIDANCE METHOD FOR ROBOT MOWER, ROBOT, CONTROL DEVICE, AND STORAGE MEDIUM

(71) Applicant: Aukey Technology CO., LTD, Shenzhen (CN)

(72) Inventors: Lixin DU, Shenzhen (CN); Bo DU, Shenzhen (CN)

(21) Appl. No.: 16/434,340

(22) Filed: Jun. 7, 2019

(30) Foreign Application Priority Data
Jan. 21, 2019 (CN) 201910055645.8

(51) Int. Cl. A01D 34/00; B60K 31/00; G05D 1/00; G05D 1/02

(52) U.S. Cl. CPC A01D 34/008; B60K 31/0008; G05D 1/0088; G05D 1/0242; G05D 1/0246; A01D 2101/00; B60K 2031/0033; B60Y 2200/80; B60Y 2300/09; G05D 2201/0208; B60K 2031/0016

(57) ABSTRACT

The present application discloses a visual obstacle avoidance method for a robot mower, which includes the following steps: acquiring self motion parameters of the robot mower; acquiring image information in front of the robot mower; collecting motion characteristic parameters of a obstacle in the image information according to the acquired image information; acquiring distance characteristic parameters between the robot mower and the obstacle. According to the motion characteristic parameters, the self motion parameters and the distance characteristic parameters, whether the robot mower needs to avoid is determined, and if the robot mower does not need to avoid the obstacle, the original driving path is executed. The present application also discloses a robot mower and a readable storage medium.

### TECHNICAL FIELD

The present application relates to the technical field of robot obstacle avoidance, and in particular to a visual obstacle avoidance method for a robot mower, a robot, a control device, and a storage medium.

### BACKGROUND

With continuous improvement of human's life standard, people demands increasingly with regards to leisure environment. Venues such as private gardens, parks, playgrounds etc. have become an optimal place for leisure and entertainment. However, private gardens, parks, playgrounds and other grasslands need to be mowed irregularly to keep aesthetics. At present, robot mowers are usually used to replace manual trimming However, robot mowers often encounter various obstacles during their work. The existing robot mowers is assisted to avoid obstacles by installing depth cameras, radars and other equipments. However, these robot mowers does not avoid obstacles selectively. Avoidance measures will still be taken even when encountering small or micro obstacles, so the interactivity is limited.

The aforementioned content is only to assist understanding of the technical solution of the present application, and does not constitute an admission of above as the prior art.

### SUMMARY

The present application aims mainly to provide a visual obstacle avoidance method for a robot mower, a robot, a control device, and a storage medium, to solve the problem of the robot mower avoiding obstacles non-selectively at present.

In order to achieve the aforementioned objective, the visual obstacle avoidance method for the robot mower provided by the application includes the following operations:

acquiring a self motion parameter of the robot mower;

acquiring image information of an image in front of the robot mower, and collecting a motion characteristic parameter of the obstacle from the acquired image information, according to the acquired image information;

acquiring a distance characteristic parameter between the robot mower and the obstacle;

determining whether the robot mower is necessary to avoid the obstacle or not, according to the motion characteristic parameters, the self motion parameters and the distance characteristic parameters; if not, executing an original driving path.

Optionally, a shape characteristic parameter of the obstacle from the acquired image information is collected according to the acquired image information, when it is determined whether avoidance is necessary; and

It is determined that whether the shape characteristic parameter meets a preset shape threshold condition; if so, stopping avoidance and executing the original driving path.

Optionally, a position of the obstacle is determined and a driving direction of the robot mower is adjusted according to the motion characteristic parameter, the self motion parameter and the distance characteristic parameter, when the shape characteristic parameter is determined failed to meet the preset shape threshold condition.

Optionally, the shape characteristic parameter includes at least an obstacle height, and whether the obstacle height meets a preset shape threshold condition is determined; if so, avoidance is terminated and the original driving path is executed.

Optionally, the operation of acquiring a distance characteristic parameter includes: acquiring in real time a distance between the robot mower and the obstacle through pulse laser, and determining in real time a position state of the obstacle according to the distance;

determining the distance between the robot mower and the obstacle, and adjusting a driving direction of the robot mower when the distance between the robot mower and the obstacles is less than or equal to a preset threshold value.

Optionally, the motion characteristic parameters include at least:

a motion angle and a motion speed; a motion track of the obstacle is obtained according to the motion angle and the motion speed, and it is determined whether avoidance is necessary or not; and if not, the original driving path is executed.

Optionally, a position where a motion track and a driving path of the robot mower intersects is determined, when it is determined whether avoidance is necessary; and the robot mower reestablishes the driving path to avoid an intersection.

Optionally, the self motion parameter of the robot mower further includes: an acceleration speed, a deflection angle and a magnetic direction;

whether the robot mower collides with the obstacle during the driving process is determined by acquiring the acceleration speed, the deflection angle and the magnetic direction, in combination with the motion angle and motion speed of the obstacle; and if not, the original driving path is executed.

In addition, in order to achieve the aforementioned objective, the present application further provides a robot mower, which includes:

a control device, comprising a memory, a processor, and a program of a visual obstacle avoidance method stored in the memory and operable on the processor; the program of the visual obstacle avoidance method is executed by the processor to implement and acquire a self motion parameter of the robot mower;

image information is acquired in front of the robot mower, and a motion characteristic parameter of the obstacle is collected from the acquired image information, according to the acquired image information;

a distance characteristic parameter is acquired between the robot mower and the obstacle; and

the robot mower is determined whether necessary to avoid the obstacle or not, according to the motion characteristic parameters, the self motion parameters and the distance characteristic parameters; if avoidance is unnecessary, an original driving path is executed; and

a mowing device, configured to perform mowing operations in a target area determined by the control device.

In addition, in order to achieve the aforementioned objective, the present application further provides a control device, which includes a memory, a processor, and a program of a visual obstacle avoidance method stored in the memory and operable on the processor; the program of the visual obstacle avoidance method is executed by the processor to implement and acquire a self motion parameter of the robot mower;

image information is acquired in front of the robot mower, and a motion characteristic parameter of the obstacle is collected from the acquired image information, according to the acquired image information;

a distance characteristic parameter is acquired between the robot mower and the obstacle; and

it is determined whether the robot mower is necessary to avoid the obstacle or not, according to the motion characteristic parameters, the self motion parameters and the distance characteristic parameters; if not, an original driving path is executed.

In addition, in order to achieve the aforementioned objective, the present application further provides a computer readable storage medium. The computer readable storage medium stores a program of a visual obstacle avoidance method, and the program of the visual obstacle avoidance method is executed by a processor to implement operations of the visual obstacle avoidance method by a robot mower as follows:

acquiring a self motion parameter of the robot mower;

acquiring image information of an image in front of the robot mower, and collecting a motion characteristic parameter of the obstacle from the acquired image information, according to the acquired image information;

acquiring a distance characteristic parameter between the robot mower and the obstacle; and

determining whether the robot mower is necessary to avoid the obstacle or not, according to the motion characteristic parameters, the self motion parameters and the distance characteristic parameters; if not, executing an original driving path.

The present application provides a visual obstacle avoidance method for a robot mower, a robot mower and a computer readable storage medium. Firstly, image information of the robot mower is acquired in a driving direction, the acquired image information is analyzed, obstacle existed in the image is identified. The motion characteristic parameter of the obstacle in the image information is determined, and the motion state of the obstacle is determined. The motion parameters of the robot mower is acquired, the motion parameters of the robot mower is analyzed, and the motion state of the robot mower is determined. And the distance is determined between the robot mower and an obstacle in front of the robot mower. It is then determined whether the robot mower is possible to meet the obstacle through the self motion parameter, the motion characteristic parameter of the obstacle and the distance between the robot mower and the obstacle. If yes, the meeting position is determined and the driving direction of the robot mower is adjusted to avoid the obstacle. If it is determined that it is possible to meet, the robot mower is executed the original driving path and continues to complete the mowing task. By monitoring the position of obstacles in real time, no avoidance measures are taken if it is determined no possibility of meeting between the obstacle and the robot mower. Thus, the robot mower is more flexible in avoiding obstacles, and the situations are avoided where part of grass is missed or less mowed, due to a complete avoidance, further improving the working efficiency of the robot mower.

### BRIEF DESCRIPTION OF THE DRAWINGS

FIG. 1 is a schematic diagram of the hardware structure of a robot mower according to an embodiment of the present application;

FIG. 2 is a schematic diagram of the hardware structure of a control device of a robot mower according to an embodiment of the present application;

FIG. 3 is a schematic flow chart of an embodiment of an obstacle avoidance method for a robot mower according to the present application; and

FIG. 4 is a detailed schematic flow chart of step S50 in FIG. 3.

The implementation, functional characteristics and advantages of the present application will be further provided with reference to the drawings in combination with embodiments.

### DETAILED DESCRIPTION OF THE EMBODIMENTS

It should be understood that the specific embodiments described herein are only for illustrative purpose and are not intended to limit the present application.

The main solution of the embodiment of the present application is as follows:

acquiring a self motion parameter of the robot mower;

acquiring image information of an image in front of the robot mower, and collecting a motion characteristic parameter of the obstacle from the acquired image information, according to the acquired image information;

acquiring a distance characteristic parameter between the robot mower and the obstacle;

determining whether the robot mower is necessary to avoid the obstacle or not, according to the motion characteristic parameters, the self motion parameters and the distance characteristic parameters; if not, executing an original driving path.

In the prior art, the obstacle avoidance method adopted by the robot mower is to detect the position of an obstacle in front of the robot mower installation of depth cameras, radars and other equipment. Avoidance measures will directly be taken even when encountering small or micro obstacles, without determining whether the obstacles are necessary to avoid. Selective avoidance is not provided and interactivity is limited.

The present application provides the above solution, aiming at solving the problem nonselective avoidance regarding the robot mower.

The present application provides a solution, which can implement the selective avoidance of obstacles by the robot mower without manual intervention during the process. The situations are avoided where part of grass is missed or less mowed, due to a complete avoidance, improving the working efficiency of the robot mower. The robot mower is able to mow in more complex topography, the applicability of the robot mower is improved.

The present application provides a robot mower. No manual operation is needed regarding the robot mower. The position of the obstacle is automatically obtained and the obstacle is comprehensively determined of whether avoidance is necessary, through the sensing device arranged on the robot mower, thus improving the applicability of the robot mower to different conditions and simultaneously improving the operation efficiency of the robot mower.

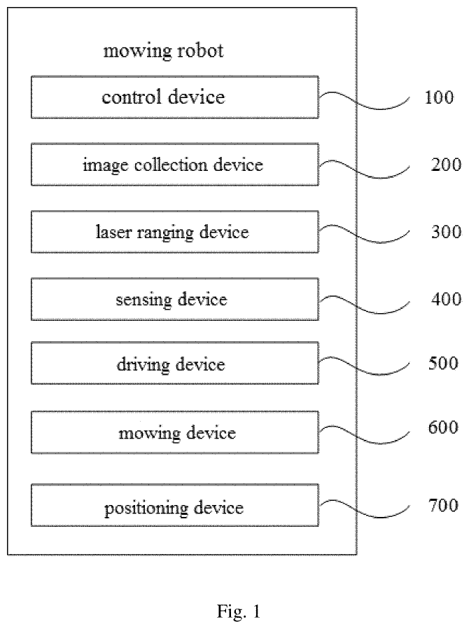

In an embodiment of the present application, referring to FIG. 1, the robot mower specifically includes a control device 100, an image collection device 200, a laser ranging device 300, a sensing device 400, a driving device 500, a mowing device 600, a positioning device 700, and the like.

Further, the mowing device 600 is electrically connected to the control device 100. The control device 100 controls the mowing device 600 to finish mowing operations in a designated area and controls the start and pause of the mowing device 600 in real time.

The image acquisition device 200 is electrically connected to the control device 100. The image acquisition device 200 acquires the image information of the moving direction of the robot mower in real time and transmits the acquired image information to the control device 100. The control device 100 acquires the motion characteristic parameters of the obstacle in the moving direction of the robot mower through analysis, and acquires the motion state of the obstacle through the change of the motion characteristic parameters, acquiring whether the obstacle is static or moving. The motion characteristic parameter of the obstacle includes: the motion angle, the motion speed, acceleration, etc. In the meanwhile, the shape characteristic parameter of the obstacle can be obtained through the image information acquired by the image acquisition device 200, and it is then determined whether the robot mower needs to avoid the obstacle by comparing the shape characteristic parameters with the preset shape characteristic threshold value of the robot mower. Selective avoidance of obstacle is thus implemented.

The laser ranging device 300, which is electrically connected to the control device 100. The laser ranging device 300 measures in real time the distance between the robot mower and obstacles in the driving direction of the robot mower. The control device 100 acquires the distance parameter and determine in real time whether the distance meets the preset distance threshold condition, thereby controlling the driving direction of the robot mower. A laser range finder uses a phase range finder by detecting phase difference between emitted light and reflected light when propagating in space. The use of phase laser range finder can enables the light overall weight of the robot mower and small in volume. Since the error of laser ranging is extremely small, which is beneficial to the operation of the robot mower by the control device 100.

The sensing device 400, which is electrically connected to the control device 100.

The sensing device 400 is used for acquiring the self motion parameters of the robot mower, including the motion acceleration, speed, deflection direction and the like of the robot mower. The control device 100 acquires the self motion parameters of the robot mower, and analyzes and determines the current motion state of the robot mower through the self motion parameters, thereby determining when and where to avoid obstacles more accurately. The accuracy of obstacle avoidance is improved, and the robot mower is prevented from being damaged due to untimely avoidance or inaccurate avoidance.

The driving device 500, which is electrically connected to the control device 100 and is used for realizing the motion and stop of the robot mower, controlling the robot mower for accurate avoidance.

The positioning device 700, which is connected to the control device 100. The control device 100 obtains in real time the position parameter of the positioning device 100 and determines the position state of the robot mower. The positioning device 700 can also be connected to other auxiliary equipment such as mobile phones, computers and the like through WiFi, GPS, GPRS and the like, facilitating the confirmation of the real-time position of the robot mower.

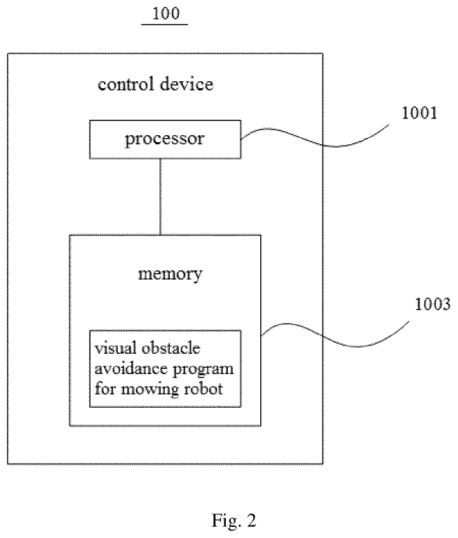

Referring to FIG. 2, the control device 100 includes a processor 1001 (e.g., CPU, etc.), a memory 1003, etc. The processor 1001 is electrically connected to a memory 1003 that may be a high-speed RAM memory or a non-volatile memory such as a disk memory. Further, the memory 1003 and the storage device may be separated from each other.

It would be understood by those skilled in the art that the device structure shown in FIG. 2 does not constitute a limitation to the device, which may include more or fewer components than shown, or some components may be combined, or different components arranged.

It should be noted that the control device 100 may be a functional module built into the robot mower.

As shown in FIG. 2, the memory 1003 as a computer storage medium may include a program of a visual obstacle avoidance method for a robot mower. In the control device 100 shown in FIG. 2, the processor 1001 can be used to call the robot mower visual obstacle avoidance program stored in the memory 1003, and execute the following related operations of the robot mower visual obstacle avoidance method.

The embodiment of the present application further provides a visual obstacle avoidance method for the robot mower.

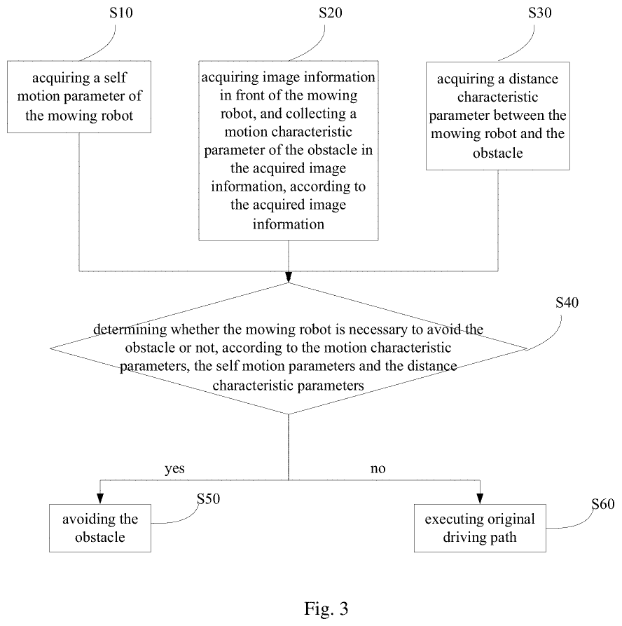

Referring to FIG. 3, in an embodiment of the visual obstacle avoidance method of the robot mower of the present application, the visual obstacle avoidance method comprises:

Step S10: acquiring a self motion parameter of the robot mower;

A sensing device is arranged in the robot mower, and the motion state of the robot mower is obtained through the sensor. Particularly, the sensor converts the sensed information into electrical signals or other forms of signals according to a certain rule. The control device 100 compares the electrical signals input by the sensor with a preset electrical signal model after obtaining the electrical signals, thereby determining the motion state of the robot mower. The specific flow process is: the state of the robot mower to be measured is directly sensed by a sensing element, and after the state is known, the physical signal output by the sensing element is converted into an electrical signal by a conversion element, and the electrical signal by a conversion element is amplified and modulated to form a final electrical signal, in order to judge the driving state of the robot mower. The motion parameter of the robot mower is the motion state of the robot mower body.

Its self motion parameter include: the motion speed, the motion acceleration, the motion angle and the inclination angle of the robot mower.

By acquiring the moving speed of the robot mower, it can be determined whether the robot mower is in a static state or in a still moving state, and the time for executing the specified path can also be calculated by the speed of the robot mower, thus control of the working time of the robot mower can be implemented.

The speed change of the robot mower can be determined by acquiring the motion acceleration, and whether the robot mower is in a deceleration state, a uniform speed state or an acceleration state can be determined by the speed change amount. After the control device 100 acquires the speed change amount, the speed change amount of the robot mower can be adjusted according to the needs of actual situation, and the robot mower can be controlled to accelerate, decelerate and move at a uniform speed, thus realizing accurate obstacle avoidance.

By obtaining the motion angle of the robot mower, it can be determined whether the robot mower deviates from the original preset direction. When the robot mower deviates, the control device 100 acquires the deviation angle, and obtains the deviation angle value by comparing the acquired deviation angle with the preset travel direction. The control device 100 controls the drive device 500 to correct the motion angle of the robot mower according to the calculated deviation angle value, so as to achieve accurate operation. In the meanwhile, in the process of obstacle avoidance, the best obstacle avoidance path can be obtained through the motion angle of the robot mower, and time for obstacle avoidance can be reduced.

By obtaining the inclination angle of the robot mower, the inclination angle where the robot mower is located can be determined. The control device 100 obtains the inclination angle where the robot mower is located, and determines whether the robot mower is at risk of rollover by comparing the obtained inclination angle with a preset inclination angle threshold. When the robot mower is at risk of rollover, the control device 100 controls the drive device 500 to stop advancing and send a feedback signal to the user.

The self motion parameters of the robot mower can be obtained through a nine-axle sensor. Of course, other sensing devices can also be used to obtain its own motion state according to the design requirements.

Step S20: acquiring image information of an image in front of the robot mower, and collecting a motion characteristic parameter of the obstacle from the acquired image information, according to the acquired image information;

The image information is obtained of the robot mower's driving direction through the depth camera. After obtaining the image information, the depth camera transmits the obtained image information to the control device 100, and the control device 100 resolves the image information to obtain a three-dimensional point cloud of the robot mower along the driving direction, establishes a coordinate system, and obtains depth information and the like of the obstacle by plotting each point of the three-dimensional point cloud in the coordinate system.

In order to ensure the accuracy of the obtained the three-dimensional point cloud of the obstacle in front, the depth camera is used to shoot objects in the same direction for many times in the same time interval to obtain at least two or more pieces of image information. The obtained image information is resolved, and the average value of each point is obtained as the final value of the point. It would be understood by those skilled in the art that the shutter speed of the camera is defined to be 1/1000 second, and the displacement of the object during this time interval can be ignored, so the error generated after averaging can also be ignored.

Furthermore, in order to enable the camera to accurately and rapidly acquire the motion characteristic parameters of obstacles, three images with the same time interval can be selected as a group for average processing. While ensuring the accuracy of acquiring image information, the processing time of the robot mower is reduced regarding the image information, and the recognition efficiency of the robot mower is improved regarding image information.

The motion characteristic parameters of the obstacle are the characterization parameters of the obstacle motion, namely the motion state of the obstacle, and the motion characteristic parameters include speed, acceleration, motion angle, etc.

When the obstacle is in a static state, the direction and the spatial size of the obstacle are obtained through a three-dimensional point cloud.

When the obstacle is in a moving state, the motion information, direction and size of the obstacle are obtained through the position change of a same point in a plurality of groups of three-dimensional point cloud, and the motion characteristic parameters of the obstacle are determined.

Step S30: acquiring a distance characteristic parameter between the robot mower and the obstacle;

The distance characteristic parameter between the robot mower and the obstacle refers to the linear distance between the robot mower and the obstacle. The robot mower is equipped with a distance sensor, and the distance between the robot mower and the obstacle is calculated by the time difference between the transmitting end and the receiving end. The distance sensor transmits the obtained distance parameter to the control device 100, and the control device 100 compares the obtained distance parameter with a preset distance threshold to determine whether the distance is within a safe distance between the robot mower and the obstacle.

S40: determining whether the robot mower is necessary to avoid the obstacle or not, according to the motion characteristic parameters, the self motion parameters and the distance characteristic parameters.

Case 1: motion characteristic parameters of the obstacle is acquired. The motion state of the obstacles is determined. A three-dimensional cloud point map of the obstacles is acquired through a depth camera when the obstacles are in a static state. Corner points of the three-dimensional cloud point map is placed in a coordinate system along the driving direction of the robot mower. It is determined whether the corner points fall at least partially into the coordinate of the driving direction of the robot mower. When that the obstacles are in the driving direction of the robot mower, step S50 is performed to avoid the obstacle, when the obstacle is in the driving direction of the robot mower; if the corner points fall partially in the driving direction of the robot mower.

When the obstacle is not in the driving direction of the robot mower, step S60 is performed to execute the original driving path.

Case 2: motion characteristic parameters of the obstacle are obtained. The motion state of the obstacles is determined through the motion characteristic parameters. When the obstacles are in the motion state, the motion speed and the motion angle of the obstacles are obtained through position changes of same points in a plurality of groups of three-dimensional point cloud measured by a depth camera. The motion speed of the robot mower is obtained through a nine-axle sensor, and it is then determined whether the robot mower meets the obstacle.

If the robot mower does not meet the obstacle in the driving direction, step S60 is performed to execute the original driving path.

If the robot mower meets the obstacle in the driving direction, step S50 is performed. In executing step S50, the robot mower obtains in real time the distance between the robot mower and the obstacle through the distance sensor. And when the distance between the robot mower and the obstacle is less than or equal to a preset distance threshold condition, the step S50 is started executing the avoidance.

The preset distance threshold condition is the best turning position between the robot mower and the obstacle. When the distance between the robot mower and the obstacle is less than or equal to the preset distance threshold condition, an avoidance program is executed.

The avoidance process is: when the obstacle is known to be a static obstacle, steering avoidance would be taken. The position information of the steering point is acquired by the positioning device 700, which can be GPS information, wireless signal strength information, etc. The obtained position information of the steering point is stored in the control device 100 for automatic avoidance when passing through the position next time.

When the obstacle is known to be a moving obstacle, the situation of missed or less mowing is avoided by adopting avoidance measures of deceleration or acceleration by the robot mower. In which, when the obstacle moves towards the robot mower, the robot mower firstly withdraws from the moving direction to perform the avoidance. As such, the robot mower moves towards a lateral side of the moving direction and records the position information of the withdrawing point. When the obstacle passes, the robot mower returns to the withdrawing point according to the recorded position information, and continues mowing. In this way, the possibility of missed or less mowing due to existence of the obstacles is avoided.

The present application provides a visual obstacle avoidance method for a robot mower, a robot mower and a computer readable storage medium. Firstly, image information of the robot mower is acquired in a driving direction, the acquired image information is analyzed, obstacle existed in the image is identified. The motion characteristic parameter of the obstacle in the image information is determined, and the motion state of the obstacle is determined. The motion parameters of the robot mower is acquired, the motion parameters of the robot mower is analyzed, and the motion state of the robot mower is determined. And the distance is determined between the robot mower and an obstacle in front of the robot mower. It is then determined whether the robot mower is possible to meet the obstacle through the self motion parameter, the motion characteristic parameter of the obstacle and the distance between the robot mower and the obstacle. If yes, the meeting position is determined and the driving direction of the robot mower is adjusted to avoid the obstacle. If it is determined that it is possible to meet, the robot mower is executed the original driving path and continues to complete the mowing task. By monitoring the position of obstacles in real time, no avoidance measures are taken if it is determined no possibility of meeting between the obstacle and the robot mower. Thus, the robot mower is more flexible in avoiding obstacles, and the situations are avoided where part of grass is missed or less mowed, due to a complete avoidance, further improving the working efficiency of the robot mower.

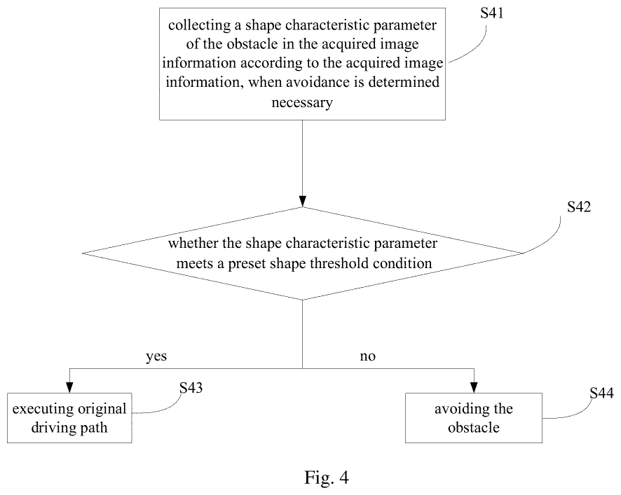

Referring to FIG. 4, in one embodiment of the present application, the visual method further comprises the following steps:

Step S41: collecting a shape characteristic parameter of the obstacle from the acquired image information according to the acquired image information, when avoidance is determined necessary;

Step S42: determining whether the shape characteristic parameter meets a preset shape threshold condition;

if so, stopping avoidance and executing the original driving path.

Shape feature parameters are characterization parameters of the shape feature of the obstacle, specifically including length, width, height, etc.

Specifically, when step S40 determines that the obstacle needs to be avoided, further, the shape characteristic parameters of the obstacle are acquired through the depth camera, and the acquired shape characteristic parameters are transmitted to the control device 100. The shape characteristic parameters at least include the height, width and length of the obstacle. The control device 100 compares the height, width and length of the obstacle with preset shape threshold conditions respectively. When the height, width and length of the obstacle meet the preset threshold conditions, step S43 that is, the original driving path is executed. When the height, width and length of the obstacle do not meet the preset shape threshold condition, step S44 is executed to perform avoidance. The preset shape threshold refers to the maximum height, width and length that the robot mower can pass through. When the threshold needs to be adjusted, a user can log in to a preset application associated with the robot mower through a mobile phone or a computer terminal, and send an instruction to change the preset shape threshold through the preset application. Of course, in order to protect the normal motion of the robot mower, the user can only adjust below the maximum range.

According to the present technical solution, when the obstacle needs to be avoided, it is further determined whether the shape characteristic parameter of the obstacle meets the preset shape threshold condition, when the preset shape threshold condition is met, avoidance operation is not required. And the situation of missing cutting or less cutting is avoided by directly executing the original driving path. The operation efficiency of the robot mower is thus improved.

In one embodiment of the present application, a position of the obstacle is determined and a driving direction of the robot mower is adjusted according to the motion characteristic parameter, the self motion parameter and the distance characteristic parameter, when the shape characteristic parameter is determined failed to meet the preset shape threshold condition.

Particularly, when step S44 is executed, the motion characteristic parameters, self motion parameters and distance characteristic parameters of the obstacles in the control device 100 are directly retrieved, the time is calculated of when the robot mower and the obstacles meets, and avoidance measures are accordingly taken.

According to the present technical solution, when it is determined that the obstacle needs to be avoided and the robot mower cannot pass, relevant calculated parameters are directly obtained through the control device, so that the responding time of the robot mower is shortened. Of course, it can be understood that the shape parameters of the robot mower and the preset shape parameter threshold value are the judgment program ranked lower relative to step S40. When it is determined that the obstacle needs to be avoided, the robot mower directly calls for the avoidance program. After entering the avoidance program, the robot mower synchronously compares the shape parameter of the robot mower with a preset shape parameter threshold value. When the condition is met, the control device 100 sends a command to terminate the execution of the avoidance, thus further shortening the corresponding time of the system. When an emergency occurs and the shape parameter cannot be determined, an avoidance measure is directly taken to prevent robot mower from being damaged due to late response.

In one embodiment of the present application, the shape characteristic parameter includes at least an obstacle height, and whether the obstacle height meets a preset shape threshold condition is determined; if so, avoidance is terminated and the original driving path is executed.

Specifically, when it is determined in step S40 that the obstacle needs to be avoided, further, the shape characteristic parameters of the obstacle are acquired through the depth camera, and the acquired shape characteristic parameters are transmitted to the control device 100. In which, the shape characteristic parameters at least include the height of the obstacle. The control device 100 compares the height of the obstacle with a preset shape threshold condition, and when the height of the obstacle meets the preset shape threshold condition, step S43 is executed and avoidance is terminated, and the original driving path is executed. In the present embodiment, only the height of the obstacle needs to be obtained, and whether the height of the obstacle meets the preset shape threshold parameter is determined, so that the next step can be determined. The determining process is reduced, and the reaction speed of the robot mower is improved regarding to the obstacle.

In one embodiment of the present application, the operation of acquiring a distance characteristic parameter includes: acquiring in real time a distance between the robot mower and the obstacle through pulse laser, and determining in real time a position state of the obstacle according to the distance;

determining the distance between the robot mower and the obstacle, and adjusting a driving direction of the robot mower when the distance between the robot mower and the obstacles is less than or equal to a preset threshold value.

Specifically, after the height of the obstacle is obtained by the depth camera, it is determined whether the height of the obstacle meets the shape threshold condition. If not, the robot mower needs to avoid the obstacle. In the avoidance process, the pulse laser measures in real time the distance between the robot mower and the obstacle, and the pulse laser transmits the obtained pulse signal to the control device 100. The control device 100 determines in real time whether the distance is less than or equal to the preset threshold, and adjusts the driving direction of the robot mower when the distance is less than or equal to the preset threshold. The pulse laser is of light weight, high precision and short measurement time, ensuring that the mowing machine can acquire the distance value between the robot mower and the obstacle in a short time. So the robot mower has enough time to react and avoids collision with the obstacle.

When the preset threshold needs to be adjusted, a user can log in to a preset application associated with the robot mower through a mobile phone or a computer terminal, and send an instruction through the preset application to change the preset threshold so as to shorten or prolong the avoidance distance of the robot mower.

In one embodiment of the present application, the motion characteristic parameters at least include:

a motion angle and a motion speed. A motion track of the obstacle is obtained according to the motion angle and the motion speed, and it is determined whether avoidance is necessary or not; and if not, the original driving path is executed.

Specifically, the depth camera acquires image signals at the same time interval, analyzes the acquired image information, and obtains a three-dimensional cloud point map. Through the position change of the three-dimensional cloud point map, the motion characteristic parameters of the obstacle is obtained which at least includes the motion angle and the motion speed. The motion track of the obstacle is obtained by acquiring in real time the motion angle and the motion speed. The control device 100 acquires this motion track, and judges whether the motion track intersects with the effective motion distance along the driving direction of the robot mower. And if so, it is determined that avoidance is needed, and if avoidance is not needed, the original driving path is executed. By drawing the image of the motion path of the obstacle, when the robot mower moves to an adjacent path, judgment is not needed for the same obstacle, and whether another avoidance is needed can be determined by calling the motion path formed in the control device to perform composite operation. The system cost is reduced, so that the robot mower can quickly identify obstacles and accurately avoid obstacles.

In one embodiment of the present application, a position where a motion track and a driving path of the robot mower intersects is determined, when avoidance is determined necessary; and the robot mower reestablishes the driving path to avoid an intersection.

Specifically, when it is determined in step S40 that avoidance is required, the position is obtained where the obstacle and the robot mower meet. Further, when a plurality of intersecting positions exist, the position information of the robot mower operation is obtained through a nine-axle sensor. The distance characteristic parameter is obtained through a pulse laser ranging device and the position information of the original position of the robot mower is obtained through the positioning device 700, the information of the intersecting position, and recorded in the controller. Avoidance is directly executed when the robot mower runs to the area. The position information may be GPS position information or coordinate information established in the mowing area.

According to the present technical solution, avoidance is executed to avoid collision. Sufficient reaction time is given to the robot mower, prevent the robot mower from being damaged caused by untimely avoidance.

In one embodiment of the present application, the self motion parameter of the robot mower further includes: an acceleration speed, a deflection angle and a magnetic direction.

It is determined whether the robot mower collides with the obstacle during the driving process by acquiring the acceleration speed, the deflection angle and the magnetic direction, in combination with the motion angle and motion speed of the obstacle; and if not, the original driving path is executed.

According to the present technical solution, the self motion state of the robot mower is determined by obtaining the motion acceleration, deflection angle and magnetic direction of the robot mower. In which the motion state of the robot mower includes acceleration motion, deceleration motion or uniform motion. The time is then obtained about when the robot mower reaches each position in the driving direction. The motion track of the obstacle is obtained by the motion angle and the motion speed of the obstacle. It is determined whether the motion track of the obstacle intersects with the driving direction of the robot mower, and the position of the intersection point is obtained. It is determined whether the time for reaching the intersection position is the same, thus determining whether the robot mower collides with the obstacle in the traveling process; if not, executing the original driving path. According to the present technical solution, it is convenient to know when the robot mower contacts with the obstacle. The obstacle avoidance operation can be completed in advance, so collision with the obstacle is directly avoided. The situation of missed or less mowing is avoided caused by avoidance measures when encountering the obstacle, and the working efficiency of the robot mower is further improved.

The aforementioned serial numbers regarding the embodiments of the present application are for description only and do not represent the superiority and inferiority of the embodiments.

It should be noted that in this document, the terms “comprising” “including” or any other variation thereof are intended to cover a non-exclusive inclusion, such that a process, method, article, or apparatus that includes a list of elements includes not only those elements but also other elements not expressly listed, or elements inherent to such process, method, article, or apparatus. Without further restrictions, an element defined by the statement “includes an” does not exclude the presence of another identical element in a process, method, article, or apparatus including the element.

From the above description of the embodiments, those skilled in the art can clearly understand that the method of the above embodiments can be implemented by means of software plus necessary general-purpose hardware platforms. Of course, it can also be implemented by means of hardware, but in many cases the former is a better embodiment. Based on this understanding, the technical solution of the present application can be embodied in the form of a software product, which is stored in a storage medium (such as ROM/RAM, magnetic disk, optical disk) as described above, and includes several instructions to cause a terminal device (which can be a mobile phone, a computer, a server, an air conditioner, or a network device, etc.) to perform the methods described in various embodiments of the present application.

The above is only an alternative embodiment of the present application, and is therefore not a limitation on the scope of the present application. Any equivalent structure or equivalent flow transformation made by using the description and drawings of the present application, or directly or indirectly applied in other related technical fields, are included in the protection scope of the present application.

What is claimed is:

1. A visual obstacle avoidance method for a robot mower, wherein the method comprises the following operations:
acquiring a self motion parameter of the robot mower;
acquiring image information of an image in front of the robot mower, and collecting a motion characteristic parameter of a obstacle from the acquired image information based on the acquired image information;
acquiring a distance characteristic parameter between the robot mower and the obstacle; and
determining whether the robot mower is needed to avoid the obstacle, according to the motion characteristic parameters, the self motion parameters, and the distance characteristic parameters; if avoidance is unnecessary, executing an original driving path.

2. The method of claim 1, wherein the method comprises,
collecting a shape characteristic parameter of the obstacle from the acquired image information based on the acquired image information, when it is determined that avoidance is needed; and
determining whether the shape characteristic parameter meets a preset shape threshold condition; if so, stopping avoiding and executing the original driving path.

3. The method of claim 2, wherein the method comprises, determining a position of the obstacle and adjusting a driving direction of the robot mower according to the motion characteristic parameter, the self motion parameter, and the distance characteristic parameter, when the shape characteristic parameter is determined failed to meet the preset shape threshold condition.

4. The method of claim 2, wherein, the shape characteristic parameter at least comprises an obstacle height, and it is determined whether the obstacle height meets a preset shape threshold condition; if so, terminating avoiding and executing the original driving path.

5. The method of claim 4, wherein,
the operation of acquiring the distance characteristic parameter comprises: acquiring in real time a distance between the robot mower and the obstacle through pulse laser, and determining in real time the position of the obstacle according to the distance;
determining the distance between the robot mower and the obstacle; and adjusting a driving direction of the robot mower when the distance between the robot mower and the obstacles is less than or equal to a preset threshold value.

6. The method of claim 1, wherein, the motion characteristic parameter at least comprise:
a motion angle and a motion speed; a motion track of the obstacle is obtained based on the motion angle and the motion speed, and it is determined whether avoidance is needed or not; and if not, executing the original driving path.

7. The method of claim 6, wherein, a position where the motion track and a driving path of the robot mower intersects is determined, when avoidance is determined to be needed; and the robot mower reestablishes the driving path to avoid the intersection.

8. The method of claim 6, wherein,
the self motion parameter of the mowing robot further comprises: an acceleration speed, a deflection angle and a magnetic direction;
it is determined whether the mowing robot collides with the obstacle during the driving process by acquiring the acceleration speed, the deflection angle and the magnetic direction, in combination with the motion angle and motion speed of the obstacle; and if not, the original driving path is executed.

9. The method of claim 2, wherein, the motion characteristic parameter at least comprise:
a motion angle and a motion speed; a motion track of the obstacle is obtained according to the motion angle and the motion speed, to determine whether avoiding is needed or not; and if not, executing the original driving path.

10. The method of claim 9, wherein, a position where a motion track and a driving path of the robot mower intersects is determined, when avoiding is determined to be needed; and the robot mower reestablishes the driving path to avoid the intersection.

11. The method of claim 9, wherein,
the self motion parameter of the mowing robot further comprises: an acceleration speed, a deflection angle and a magnetic direction;
it is determined whether the mowing robot collides with the obstacle during the driving process by acquiring the acceleration speed, the deflection angle and the magnetic direction, in combination with the motion angle and motion speed of the obstacle; and if not, the original driving path is executed.

12. The method of claim 3, wherein, the motion characteristic parameter at least comprise:
a motion angle and a motion speed; a motion track of the obstacle is obtained according to the motion angle and the motion speed, to determine whether avoiding is needed or not; and if not, executing the original driving path.

13. The method of claim 12, wherein, a position where a motion track and a driving path of the robot mower intersects is determined, when avoidance is determined necessary; and the robot mower reestablishes the driving path to avoid the intersection.

14. The method of claim 12, wherein,
the self motion parameter of the mowing robot further comprises: an acceleration speed, a deflection angle and a magnetic direction;
it is determined whether the mowing robot collides with the obstacle during the driving process by acquiring the acceleration speed, the deflection angle and the magnetic direction, in combination with the motion angle and motion speed of the obstacle; and if not, the original driving path is executed.

15. The method of claim 4, wherein, the motion characteristic parameter at least comprise:
a motion angle and a motion speed; a motion track of the obstacle is obtained according to the motion angle and the motion speed, and it is determined whether avoidance is necessary or not; and if not, executing the original driving path.

16. The method of claim 15, wherein, a position where the motion track and a driving path of the robot mower intersects is determined, when avoidance is determined necessary; and the robot mower reestablishes the driving path to avoid the intersection.

17. The method of claim 15, wherein,
the self motion parameter of the mowing robot further comprises: an acceleration speed, a deflection angle and a magnetic direction;
it is determined whether the mowing robot collides with the obstacle during the driving process by acquiring the acceleration speed, the deflection angle and the magnetic direction, in combination with the motion angle and motion speed of the obstacle; and if not, the original driving path is executed.

18. A robot mower, wherein, the robot mower comprises:
a control device, comprising a memory, a processor, and a program of a visual obstacle avoidance method stored in the memory and operable on the processor; the program of the visual obstacle avoidance method when be executed by the processor to implement and acquire a self motion parameter of the robot mower;
acquire image information of an image in front of the robot mower, and collect a motion characteristic parameter of a obstacle from the acquired image information, according to the acquired image information;
acquire a distance characteristic parameter between the robot mower and the obstacle; and
determine whether the robot mower is needed to avoid the obstacle or not, according to the motion characteristic parameters, the self motion parameters, and the distance characteristic parameters; if avoidance is unnecessary, execute an original driving path; and
a mowing device, configured to perform mowing operations in a target area determined by the control device.

19. A control device, comprising a memory, a processor, and a program of a visual obstacle avoidance method stored in the memory and operable on the processor; the program of the visual obstacle avoidance method when being executed by the processor to acquire a self motion parameter of the robot mower;
acquire image information of an image in front of the robot mower, and collect a motion characteristic parameter of a obstacle from the acquired image information, according to the acquired image information;
acquire a distance characteristic parameter between the robot mower and the obstacle; and
determine whether the robot mower is needed to avoid the obstacle or not, according to the motion characteristic parameters, the self motion parameters, and the distance characteristic parameters; if avoidance is unnecessary, execute an original driving path; and
a mowing device, configured to perform mowing operations in a target area determined by the control device.
